(19) United States
(12) Patent Application Publication
(10) Pub. No.: US 2024/0273681 A1
(43) Pub. Date: Aug. 15, 2024

(54) METHOD, APPARATUS, DEVICE AND STORAGE MEDIUM FOR VIDEO PROCESSING

(71) Applicant: Beijing Zitiao Network Technology Co., Ltd., Beijing (CN)

(72) Inventor: Jiabin Huang, Beijing (CN)

(21) Appl. No.: 18/569,566

(22) PCT Filed: Sep. 14, 2022
(86) PCT No.: PCT/CN2022/118679

§ 371 Date: Dec. 12, 2023

(30) Foreign Application Priority Data
Sep. 29, 2021 (CN) 202111154001.8
Sep. 29, 2021 (CN) 202111154474.8

(51) Int. Cl. G06T 5/50; G06T 3/40; G06T 7/194; G06V 10/24; G06V 10/25; G06V 10/44; G06V 10/762

(52) U.S. Cl. CPC G06T 5/50; G06T 3/40; G06T 7/194; G06V 10/245; G06V 10/25; G06V 10/44; G06V 10/762; G06T 2207/20221; G06T 2207/30196; G06V 2201/07

(57) ABSTRACT

Embodiments of the disclosure disclose a method, apparatus, device and storage medium for video processing. The method includes: acquiring an original image and an original audio; performing target object segmentation on the original image to obtain a target object image and a background image; performing accent recognition on the original audio to obtain an accented audio; adjusting a size of the target object image according to different adjustment proportions to obtain a plurality of adjusted target object images; fusing the plurality of adjusted target object images respectively with the background image to obtain a plurality of target images; and performing audio and video encoding on the plurality of target images and the accented audio to obtain a target video.

### CROSS REFERENCE

The present application claims priority of Chinese Patent Application No. 202111154474.8 filed on Sep. 29, 2021, and priority of Chinese Patent Application No. 202111154001.8 filed on Sep. 29, 2021, both of which are incorporated herein by reference in their entireties.

### FIELD

Embodiments of the present disclosure relate to the field of image processing technologies, and more particularly, to a method, apparatus, device and storage medium for video processing.

### BACKGROUND

With continuous maturity of photography technologies in smart terminals, users are increasingly fond of using smart terminals to take photos and record videos to record their lives. Thus, a large number of photos and videos are obtained, and the captured videos are posted and shared online. In practical scenarios, users prefer to perform secondary processing on photos and videos stored at the terminal before sharing, for example, refining photos or making photos into videos, to increase interest. In related technologies, users usually have to process pictures manually to generate videos or edit videos, which not only results in low efficiency, but also results in failure to achieve desired effect of edited images and videos.

### SUMMARY

The embodiments of the present disclosure provide a method, apparatus, device and storage medium for video processing, which may not only improve the efficiency of video processing, but also improve a playback effect of a video and enrich effect presented by the processed video.

In a first aspect, an embodiment of the present disclosure provides a method for video processing. The method includes:
acquiring an original image and an original audio;
performing target object segmentation on the original image to obtain a target object image and a background image;
performing accent recognition on the original audio to obtain an accented audio;
adjusting a size of the target object image according to different adjustment proportions to obtain a plurality of adjusted target object images;
fusing the plurality of adjusted target object images respectively with the background image to obtain a plurality of target images; and
performing audio and video encoding on the plurality of target images and the accented audio to obtain a target video.

In a second aspect, an embodiment of the present disclosure further provides an apparatus for video processing. The apparatus includes:
an original audio acquiring module configured to acquire an original image and an original audio;
an image segmenting module configured to perform target object segmentation on the original image to obtain a target object image and a background image;
an accent recognizing module configured to perform accent recognition on the original audio to obtain an accented audio;
a target object image size adjusting module configured to adjust a size of the target object image according to different adjustment proportions to obtain a plurality of adjusted target object images;
a target image acquiring module configured to fuse the plurality of adjusted target object images respectively with the background image to obtain a plurality of target images; and
a target video acquiring module configured to perform audio and video encoding on the plurality of target images and the accented audio to obtain a target video.

In a third aspect, an embodiment of the present disclosure further provides an electronic device. The electronic device includes:
one or more processing devices;
a storage device configured to store one or more programs, wherein
the one or more programs, when executed by the one or more processing devices, cause the one or more processing devices to implement the method for video processing according to the embodiments of the present disclosure.

In a fourth aspect, an embodiment of the present disclosure further provides a computer readable medium having a computer program stored thereon, wherein the program is executed by a processing device to implement the method for video processing according to the embodiments of the present disclosure.

### BRIEF DESCRIPTION OF THE DRAWINGS

FIG. 1 is a flowchart of a method for video processing according to an embodiment of the present disclosure;

FIG. 2 is a group of exemplary diagrams of performing target object segmentation on an original image or a video frame according to an embodiment of the present disclosure;

FIG. 3 is a schematic diagram of an image segmentation model according to an embodiment of the present disclosure;

FIG. 4 is a schematic structural diagram of an apparatus for video processing according to an embodiment of the present disclosure;

FIG. 5 is a structural schematic diagram of an electronic device according to an embodiment of the present disclosure;

FIG. 6 is a flowchart of a method for video processing according to another embodiment of the present disclosure; and

FIG. 7 is a structural schematic diagram of an apparatus for video processing according to another embodiment of the present disclosure.

### DETAILED DESCRIPTION

It should be understood that various steps described in the method implementations of the present disclosure may be executed in different orders and/or in parallel. Further, the method implementations may include additional steps and/or omit execution of the shown steps. The scope of the present disclosure will not be limited in this regard.

The term “including” and variants thereof used herein are open inclusions, that is, “including but not limited to”. The term “based on” is “at least partially based on”. The term “one embodiment” represents “at least one embodiment”. The term “another embodiment” represents “at least one other embodiment”. The term “some embodiments” represents “at least some embodiments”. Relevant definitions of other terms will be given in description below.

It should be noted that concepts such as “first” and “second” as mentioned in the present disclosure are only used to distinguish different apparatuses, modules or units, but not to define orders or interdependence of functions executed by these apparatuses, modules or units.

It should be noted that modification of “one” and “a plurality of” as mentioned in the present disclosure is exemplary rather than restrictive, and those skilled in the art should understand that unless otherwise explicitly specified in the context, it should be understood as “one or more”.

Names of messages or information interacted between a plurality of apparatuses according to the implementations of the present disclosure are only used for illustrative purposes, and are not used to limit the scope of these messages or information.

In this embodiment, an objective is to make a generated video have a “kichiku” effect. The “kichiku” effect usually has the following characteristics of: repeated playback of the same clip, clip playback combined with accent, mirror image flip, effect of zoom in/out, etc. In order to achieve the above-described effect, pictures need to be processed by using the technical solution disclosed by this embodiment.

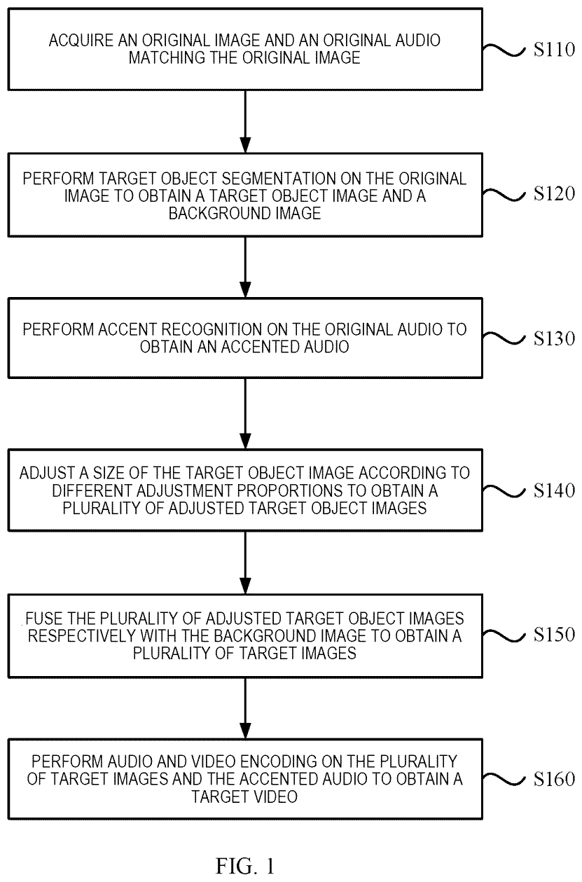

FIG. 1 is a flowchart of a method for video processing provided by Embodiment 1 of the present disclosure. This embodiment may be applicable to a case of generating a video based on pictures. The method may be performed by an apparatus for video processing. The apparatus may be composed of hardware and/or software and may usually be integrated into a device having a video processing function. The device may be an electronic device such as a server, a mobile terminal, or a server cluster. As shown in FIG. 1, the method includes the following steps.

In 110, an original image and an original audio matching the original image are acquired.

The original image may be captured by a user through a camera of a smart terminal, or stored locally, or downloaded from a picture library in a network, or sent by other user. A source of the original image will not be limited here. The original audio may be an audio with a strong sense of rhythm.

In this embodiment, a mode of acquiring the original audio matching the original image may be: acquiring the original audio matching the original image according to a selection operation of the user; or recognizing type information of the original image; and acquiring the original audio matching the original image based on the type information.

The mode of selecting by the user may be specifying an audio by the user, or selecting by the user after acquiring an audio template provided by an APP.

The mode of recognizing the type information of the original image may be: inputting the original image into a type recognition model to obtain a type to which the original image belongs. The type recognition model may be obtained by training a set neural network. For example, after determining the type information of the original image, a clip of audio is randomly selected from an audio library corresponding to the type information as the original audio. Types may include a natural scenery type, a character type, a building type, etc.

In 120, target object segmentation is performed on the original image to obtain a target object image and a background image.

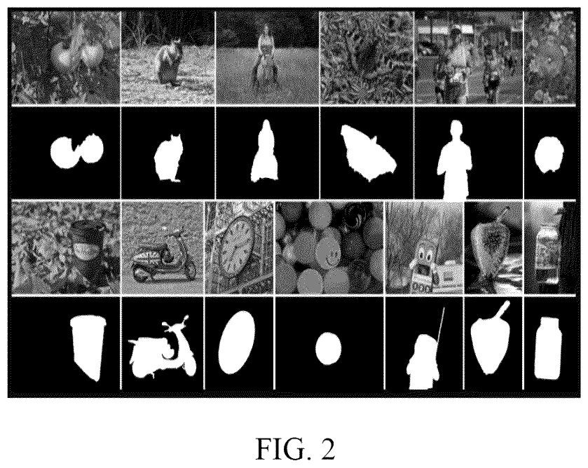

The target object may be a human body or a subject object contained in the original image. In this embodiment, the target object in the original image needs to be recognized firstly; and then, the recognized target object is segmented from the background to obtain the target object image and the background image. Exemplarily, FIG. 2 is a group of exemplary diagrams of performing target object segmentation on the original image in this embodiment. As shown in FIG. 2, the target object may be a fruit, an animal, a human body, or a vehicle, etc.

For example, the process of performing target object segmentation on the original image to obtain the target object image and the background image may be: performing human figure recognition on the original image; determining the recognized human figure as the target object in response to recognizing a human figure; performing subject object recognition on the original image, and determining the recognized subject object as the target object, in response to recognizing no human figure; and segmenting the target object from the background to obtain the target object image and the background image.

In this embodiment, a human body is firstly taken as the target object. In the absence of a human figure in the original image, a subject object in the original image may be recognized by using a saliency segmentation algorithm. For example, firstly human figure recognition is performed on the original image. The human figure is segmented from the background to obtain a human body image and a background image in response to recognizing a human figure; and subject object recognition is performed on the original image by using the saliency segmentation algorithm, and the subject object is segmented from the background to obtain a subject object image and a background image, in response to recognizing no human figure.

For example, if a plurality of human figures is recognized in the original image, a human figure whose size ratio is largest in the original image may be taken as the target object.

For example, the mode of performing target object segmentation on the original image to obtain the target object image and the background image may also be: inputting the original image into an image segmentation model to obtain the target object image and the background image.

In this embodiment, in order to allow the model to be deployed on a mobile terminal, the model needs to be efficient and simple in computation with low computational complexity. In the embodiments of the present disclosure, a convolutional network is a deep separable convolutional network.

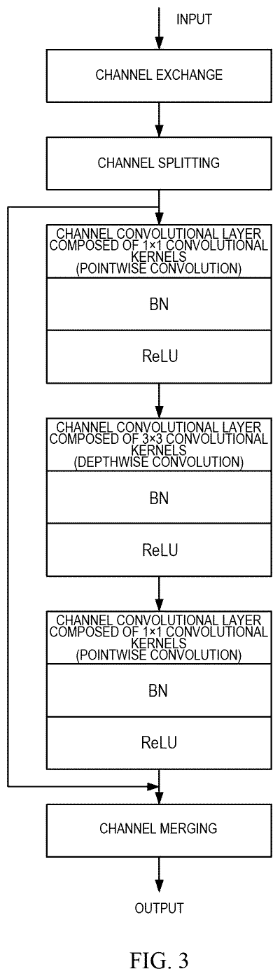

FIG. 3 is a schematic diagram of an image segmentation model in this embodiment. As shown in FIG. 3, the image segmentation model includes: a channel exchange network, a channel split network, and a deep separable convolutional network. The deep separable convolutional network includes a first channel convolutional sub-network, a deep convolutional sub-network, a second channel convolutional sub-network, and a channel merge layer. The channel exchange network, the channel split network, the first channel convolutional sub-network, the deep convolutional sub-network, the second channel convolutional sub-network and the channel merge layer are sequentially connected; and an output of the channel split network is in skip connection with an input of the channel merge layer. The first channel convolutional sub-network includes a first channel convolutional layer, a nonlinear activation layer and a linear transformation layer. The deep convolutional sub-network includes a deep convolutional layer (for depthwise convolution), a nonlinear activation layer and a linear transformation layer. The second channel convolutional sub-network includes a second channel convolutional layer (for pointwise convolution), a nonlinear activation layer and a linear transformation layer. The deep convolutional layer is composed of a plurality of parallel convolutional kernels.

Both the first channel convolutional layer and the second channel convolutional layer may be composed of 1×1 convolutional kernels. The deep convolutional layer may be composed of 3×3 convolutional kernels; the 3×3 convolutional kernels are composed of three parallel convolutional kernels; and the three parallel convolutional kernels have sizes of 3×3, 3×1 and 1×3, respectively. The channel exchange network may be implemented through channel shuffle. The nonlinear activation layer may be implemented by a rectified linear unit (ReLU). The linear transformation layer may be implemented by using a batch normalization (BN) algorithm. A vector field prediction model provided by this embodiment is less time-consuming in operation, and may be applied to a mobile terminal with high requirements on time consumption.

In 130, accent recognition is performed on the original audio to obtain an accented audio.

The accent may be understood as a note with a strong sense of rhythm.

In this embodiment, the mode of performing accent recognition on the original audio to obtain the accented audio may be: denoising the original audio; detecting a note start point of the denoised original audio to obtain the note start point; detecting a peak of the denoised original audio by using a peak-picking algorithm to obtain a peak point meeting set conditions; and determining the accented audio according to the peak point and the note start point.

The note start point of the audio may be detected by using an onset function. A principle of the peak-picking algorithm may be as follows: a waveform corresponding to the accented audio is acquired, and a first-order difference value of each point in the waveform is calculated; and if a certain point meets conditions that a difference value before this point is greater than 0 and a difference value after this point is less than 0, this point may be considered as a peak point. In this embodiment, whether an amplitude of the extracted peak point is greater than a set threshold also needs to be determined for the extracted peak point; if the amplitude of the peak point is greater than the set threshold, the peak point meets the set conditions; and if the amplitude of the peak point is less than or equal to the set threshold, the peak point does not meet the set conditions.

The process of determining the accented audio according to the peak point and the note start point may be: acquiring two adjacent note start points in front of and rear of the peak point, such that an audio between the front adjacent note start point and the rear adjacent note start point is the accented audio.

In 140, a size of the target object image is adjusted according to different adjustment proportions to obtain a plurality of adjusted target object images.

The adjustment proportion may be an arbitrary value greater than 1. Since the adjustment proportion is greater than 1, the adjusted target object image is larger than the original target object image. In this embodiment, when the size of the target object image is adjusted, the adjustment proportion may increase firstly and then decrease according to a certain step length. In this way, the video has such an effect that the target object gradually becomes larger and then gradually becomes smaller to the original size. Exemplarily, assuming that there are a total of 20 images, the first 15 images are set to have an adjustment proportion changed from 1 to 2 according to a first change step length; and the last 5 images are set to have an adjustment proportion changed from 2 to 1 according to a second change step length.

For example, the process of adjusting the size of the target object image according to different adjustment proportions to obtain the plurality of adjusted target object images may be: determining a required number of images according to a duration of the accented audio; determining a change mode of the adjustment proportion according to the number of images to obtain a plurality of different adjustment proportions; and adjusting the size of the target object image respectively according to the plurality of different adjustment proportions to obtain the adjusted target object images corresponding to the number of images.

The change mode includes a change trend and a change step length. The change trend may increase firstly and then decrease; and the change step length is determined by the number of images and the maximum adjustment proportion. The number of adjustment proportions is equal to the number of images. In this embodiment, the duration of the accented audio may be multiplied by a frame rate of the video to obtain the required number of images. Exemplarily, assuming that the duration of the accented audio is 2 seconds and the frame rate of the video is 15, the required number of images is 30.

For example, the process of determining a change mode of the adjustment proportions according to the number of images to obtain the plurality of different adjustment proportions may be: assuming that the maximum adjustment proportion is M and the number of images is N, setting adjustment proportions corresponding to the number of first a % of images to change from small to large, that is, from 1 to M, such that the first change step length is (M−1)/(a%*N−1); and setting adjustment proportions corresponding to the number of last (1−a%) of images to change from large to small, that is, from M to 1, such that the second change step length is (M−1)/((1−a%)*N−1). After the plurality of different adjustment proportions is acquired, the target object images are sequentially adjusted according to different adjustment proportions to obtain the plurality of adjusted target object images.

In 150, the plurality of adjusted target object images is fused with the background image respectively to obtain a plurality of target images.

For example, the process of fusing the plurality of adjusted target object images respectively with the background image may be: firstly, determining position information of a target object image in the original image, and then directly pasting the target object image back into the original image according to this position to obtain a target image.

In 160, audio and video encoding is performed on the plurality of target images and the accented audio to obtain a target video.

In this embodiment, the plurality of target images needs to be aligned with the accented audio, followed by audio and video encoding.

The accented audio includes an accent start point and an accent end point. The process of encoding the plurality of target images and the accented audio to obtain the target video may be: aligning a first frame in the plurality of target images with the accent start point, and aligning a last frame in the plurality of target images with the accent end point; and performing audio and video encoding on the aligned target images and accented audio to obtain the target video.

The audio and video encoding mode may be implemented in an arbitrary mode in the related technologies, and will not be limited here.

For example, prior to performing audio and video encoding on the plurality of images with the accented audio, the method further includes the steps of: extracting a target region from the plurality of target images; and executing at least one of the following processing on the target region: randomly zooming in the target region, randomly zooming out the target region, or performing mirror image rotation on the target region.

The target region contains some or all pixel points of the target object; and a center point of the target region is a pixel point of the target object. Randomly zooming in the target region may be understood as zooming in along an arbitrary direction of the target region, rather than equally-proportionally zooming in. Similarly, randomly zooming out of the target region may be understood as zooming out along an arbitrary direction of the target region, rather than equally-proportionally zooming out. In this embodiment, the plurality of target regions may be executed with same or different processing. For example, the target region in a first frame is executed with processing such as randomly zooming in and mirror image rotation, and the target region in a second frame is executed with processing such as randomly zooming out.

In the technical solution of this embodiment of the present disclosure, the original image and the original audio matching the original image are acquired; target object segmentation is performed on the original image to obtain the target object image and the background image; accent recognition is performed on the original audio to obtain the accented audio; the size of the target object image is adjusted according to different adjustment proportions to obtain the plurality of adjusted target object images; the plurality of adjusted target object images is fused with the background image respectively to obtain the plurality of target images; and audio and video encoding is performed on the plurality of target images and the accented audio to obtain the target video. In the method for video processing provided by this embodiment of the present disclosure, audio and video encoding is performed on the target object image having the adjusted size and the accented audio to obtain the target video, so that the target video has a “kichiku” effect, which not only improves the efficiency of video generation, but also enriches effect presented by the generated video.

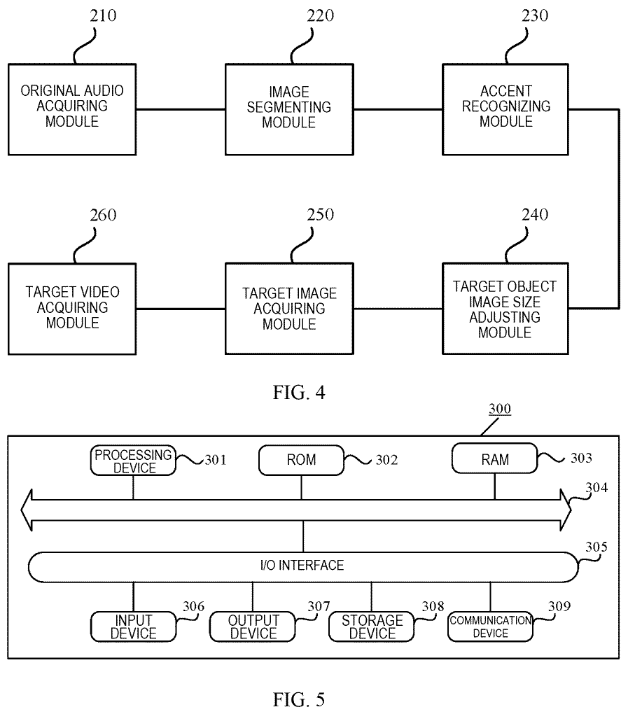

FIG. 4 is a schematic structural diagram of an apparatus for video processing provided by an embodiment of the present disclosure. As shown in FIG. 4, the apparatus includes:
an original audio acquiring module 210 configured to acquire an original image and an original audio matching the original image;
an image segmenting module 220 configured to perform target object segmentation on the original image to obtain a target object image and a background image;
an accent recognizing module 230 configured to perform accent recognition on the original audio to obtain an accented audio;
a target object image size adjusting module 240 configured to adjust a size of the target object image according to different adjustment proportions to obtain a plurality of adjusted target object images;
a target image acquiring module 250 configured to fuse the plurality of adjusted target object images respectively with the background image to obtain a plurality of target images; and
a target video acquiring module 260 configured to perform audio and video encoding on the plurality of target images and the accented audio to obtain a target video.

For example, the original audio acquiring module 210 is further configured to:
acquire the original audio matching the original image according to a selection operation of a user; or
recognize type information of the original image, and acquire the original audio matching the original image based on the type information.

For example, the image segmenting module 220 is further configured to:
perform human figure recognition on the original image;
determine the recognized human figure as a target object in response to recognizing a human figure;
perform subject object recognition on the original image, and determine the recognized subject object as a target object in response to recognizing no human figure; and
segment the target object from a background to obtain a target object image and a background image.

For example, the accent recognizing module 230 is further configured to: denoise the original audio;
detect a note start point of the denoised original audio to obtain a note start point;
detect a peak of the denoised original audio by using a peak-picking algorithm to
obtain a peak point meeting set conditions; and
determine the accented audio according to the peak point and the note start point.

For example, the target object image size adjusting module 240 is further configured to:
determine a required number of images according to a duration of the accented audio;
determine a change mode of the adjustment proportion according to the number of images to obtain a plurality of different adjustment proportions, wherein the change mode includes a change trend and a change step length;
adjust a size of the target object image respectively according to the plurality of different adjustment proportions to obtain adjusted target object images corresponding to the number of images.

For example, the target video acquiring module 260 is further configured to:
align a first frame in the plurality of target images with an accent start point, and align a last frame in the plurality of target images with an accent end point; and
perform audio and video encoding on the aligned target images and accented audio aligned to obtain a target video.

For example, the apparatus further includes a target region processing module configured to:
extract a target region from the plurality of target images, wherein the target region contains some or all pixel points of the target object, and a center point of the target region is a pixel point of the target object; and
execute at least one of the following processing on the target region:
randomly zooming in the target region, randomly zooming out the target region, or performing mirror image rotation on the target region.

For example, the image segmenting module 220 is further configured to:
input the original image into an image segmentation model to obtain the target object image and the background image, wherein the image segmentation model includes: a channel exchange network, a channel split network and a deep separable convolutional network.

The deep separable convolutional network includes a first channel convolutional sub-network, a deep convolutional sub-network, a second channel convolutional sub-network and a channel merge layer.

The channel exchange network, the channel split network, the first channel convolutional sub-network, the deep convolutional sub-network, the second channel convolutional sub-network and the channel merge layer are sequentially connected; and an output of the channel split network is in skip connection with an input of the channel merge layer.

The first channel convolutional sub-network includes a first channel convolutional layer, a nonlinear activation layer and a linear transformation layer; the deep convolutional sub-network includes a deep convolutional layer, a nonlinear activation layer and a linear transformation layer; the second channel convolutional sub-network includes a second channel convolutional layer, a nonlinear activation layer and a linear transformation layer; and the deep convolutional layer is composed of a plurality of parallel convolutional kernels.

The above-described apparatus may execute the method provided by all the foregoing embodiments of the present disclosure, and has the corresponding functional modules and advantageous effect of executing the above-described method. The technical details which are not fully described in this embodiment may refer to the method provided by all the foregoing embodiments of the present disclosure.

Hereinafter, referring to FIG. 5, it shows a schematic structural diagram of an electronic device 300 suitable for implementing the embodiment of the present disclosure. The electronic device according to the embodiment of the present disclosure may include but not limited to a mobile terminal such as a mobile phone, a laptop, a digital broadcast receiver, a personal digital assistant (PDA), a portable Android device (PAD), a portable multimedia player (PMP) or a vehicle-mounted terminal (e.g., a vehicle-mounted navigation terminal), and a stationary terminal such as a digital TV or a desktop computer, or various forms of servers, such as independent servers or server clusters. The electronic device shown in FIG. 5 is only an example and should not impose any limitation on functionality and scope of use of the embodiment of the present disclosure.

As shown in FIG. 5, the electronic device 300 may include a processing device (e.g., a central processing unit or a graphics processing unit) 301, which may execute various appropriate actions and processing according to a program stored in a read-only memory (ROM) 302 or a program loaded from a storage device 308 into a random access memory (RAM) 303. The RAM 303 further stores various programs and data required for operation of the electronic device 300. The processing device 301, the ROM 302, and the RAM 303 are connected with each other through a bus 304. An input/output (I/O) interface 305 is also connected to the bus 304.

Usually, the following apparatuses may be connected to the I/O interface 305: input device 306 including, for example, a touch screen, a touch pad, a keyboard, a mouse, a camera, a microphone, an accelerometer and a gyroscope; output device 307 including, for example, a liquid crystal display (LCD), a speaker and a vibrator; storage device 308 including, for example, a magnetic tape and a hard disk; and a communication device 309. The communication device 309 may allow the electronic device 300 to perform wireless or wired communication with other device so as to exchange data. Although FIG. 5 shows the electronic device 300 including various apparatuses, it should be understood that, it is not required to implement or have all the apparatuses shown. Alternatively, more or fewer apparatuses may be implemented or possessed.

According to the embodiments of the present disclosure, the process described above with reference to a flowchart may be implemented as a computer software program. For example, an embodiment of the present disclosure includes a computer program product, including a computer program carried on a computer readable medium, the computer program including program codes for executing the method for video processing. In such embodiments, the computer program may be downloaded and installed from a network via the communication device 309, or installed from the storage device 308, or installed from the ROM 302. When executed by the processing device 301, the computer program may execute the above-described functions defined in the methods according to the embodiments of the present disclosure.

It should be noted that, the above-described computer readable medium according to the present disclosure may be a computer readable signal medium or a computer readable storage medium or any combination of the above two media. The computer readable storage medium may be, for example, but not limited to, an electronic, magnetic, optical, electromagnetic, infrared, or semiconductor system, apparatus, or device, or any suitable combination of the above. More specific examples of the computer readable storage medium may include, but not limited to: an electrical connection having one or more leads, a portable computer diskette, a hard disk, a random access memory (RAM), a read-only memory (ROM); an erasable programmable read-only memory (EPROM or flash memory); an optical fiber, a portable compact disc read-only memory (CD-ROM); an optical storage device; a magnetic storage device; or any suitable combination of the above. In the present disclosure, a computer readable storage medium may be any tangible medium that includes or stores a program that may be used by or in conjunction with an instruction executing system, apparatus or device. Rather, in the present disclosure, the computer readable signal medium may include a data signal propagated in a baseband or as a portion of a carrier wave, which carries a computer readable program code therein. Such propagated data signals may take a variety of forms, including but not limited to, electromagnetic signals, optical signals, or any suitable combination of the above. The computer readable signal medium may also be any computer readable medium other than a computer readable storage medium. The computer readable signal medium may send, propagate, or transmit programs for use by or in combination with the instruction executing system, apparatus or device. The program code contained on the computer readable medium may be transmitted by using any suitable medium, including, but not limited to, an electrical wire, an optical cable, a radio frequency (RF), etc., or any suitable combination of the above. The computer readable storage medium may be a non-temporary computer readable storage medium.

In some implementations, the client and the server may communicate with any network protocol currently known or to be researched and developed in the future such as HyperText transfer protocol (HTTP), and may communicate (e.g., via a communication network) and interconnect with digital data in any form or medium. Examples of communication networks include a local area network (“LAN”), a wide area network (“WAN”), extranet (e.g., Internet), and an end-to-end network (e.g., an ad hoc end-to-end network), as well as any network currently known or to be researched and developed in the future.

The above-described computer readable medium may be included in the above-described electronic device; or may also exist alone without being assembled into the electronic device.

The above-described computer readable medium carries one or more programs. When executed by the electronic device, the above-described one or more programs cause the electronic device to execute the steps of: acquiring an original image and an original audio matching the original image; performing target object segmentation on the original image to obtain a target object image and a background image; performing accent recognition on the original audio to obtain an accented audio; adjusting a size of the target object image according to different adjustment proportions to obtain a plurality of adjusted target object images; fusing the plurality of adjusted target object images respectively with the background image to obtain a plurality of target images; and performing audio and video encoding on the plurality of target images and the accented audio to obtain a target video.

The computer program codes for executing the operations according to the present disclosure may be compiled in one or more programming languages or a combination thereof. The above-described programming languages include, but are not limited to, object-oriented programming languages such as Java, Smalltalk and C++, and also include conventional procedural programming languages such as “C” language or similar programming languages. The program codes may be executed entirely on a user computer, partly on the user computer, as a stand-alone software package, partly on the user computer and partly on a remote computer, or entirely on the remote computer or server. In a case of involving the remote computer, the remote computer may be connected to the user computer through any type of network, including a local area network (LAN) or a wide area network (WAN), or to an external computer (e.g., through the Internet using an Internet service provider).

The flowchart and block diagrams in the accompanying drawings illustrate the architecture, functionality, and operation of possible implementations of systems, methods and computer program products according to various embodiments of the present disclosure. In this regard, each block in the flowchart or block diagrams may represent a module, a program segment, or a portion of codes, the module, the program or the portion of codes including one or more executable instructions for implementing specified logical functions. It should also be noted that, in some alternative implementations, the functions illustrated in the blocks may occur out of the order illustrated in the accompanying drawings. For example, two blocks shown in succession may, in fact, be executed substantially concurrently, or may sometimes be executed in a reverse order, depending upon the functionality involved. It should also be noted that, each block in the block diagrams and/or flowcharts, and combinations of blocks in the block diagrams and/or flowcharts, may be implemented by dedicated hardware-based systems that execute specified functions or operations, or may also be implemented by a combination of dedicated hardware and computer instructions.

The units involved in the embodiments of the present disclosure may be implemented by means of software or hardware. A name of each unit does not constitute any limitation of the unit per se in some cases.

The functions described herein above may be executed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium, which may include or store programs for use by or in combination with an instruction executing system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above contents. A more specific example of the machine-readable storage medium may include an electrical connection based on one or more lines, a portable computer disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above contents.

According to one or more of the embodiments of the present disclosure, an embodiment of the present disclosure discloses a method for video processing. The method includes:
acquiring an original image and an original audio matching the original image;
performing target object segmentation on the original image to obtain a target object image and a background image;
performing accent recognition on the original audio to obtain an accented audio;
adjusting a size of the target object image according to different adjustment proportions to obtain a plurality of adjusted target object images;
fusing the plurality of adjusted target object images respectively with the background image to obtain a plurality of target images; and
performing audio and video encoding on the plurality of target images and the accented audio to obtain a target video.

For example, the acquiring the original audio matching the original image includes:
acquiring the original audio matching the original image according to a selection operation of a user; or
recognizing type information of the original image; and
acquiring the original audio matching the original image based on the type information.

For example, the performing target object segmentation on the original image to obtain the target object image and the background image includes:
performing human figure recognition on the original image;
determining the recognized human figure as a target object in response to recognizing a human figure;
performing subject object recognition on the original image, and determining the recognized subject object as a target object, in response to recognizing no human figure; and
segmenting the target object from the background to obtain the target object image and the background image.

For example, the performing accent recognition on the original audio to obtain the accented audio includes:
denoising the original audio;
detecting a note start point of the denoised original audio to obtain the note start point;
detecting a peak of the denoised original audio by using a peak-picking algorithm to obtain a peak point meeting set conditions; and
determining the accented audio according to the peak point and the note start point.

For example, the adjusting the size of the target object image according to different adjustment proportions to obtain the plurality of adjusted target object images includes:
determining a required number of images according to a duration of the accented audio;
determining a change mode of the adjustment proportion according to the number of images to obtain a plurality of different adjustment proportions, wherein the change mode includes a change trend and a change step length;
adjusting the size of the target object image respectively according to the plurality of different adjustment proportions to obtain adjusted target object images corresponding to the number of images.

For example, the accented audio includes an accent start point and an accent end point. The encoding the plurality of target images and the accented audio to obtain the target video includes:
aligning a first frame in the plurality of target images with the accent start point, and aligning a last frame in the plurality of target images with the accent end point; and
performing audio and video encoding on the aligned target images and accented audio to obtain the target video.

For example, prior to performing audio and video encoding on the plurality of images and the accented audio, the method further includes:
extracting a target region from the plurality of target images, wherein the target region contains some or all pixel points of the target object, and a center point of the target region is a pixel point of the target object; and
executing at least one of the following processing on the target region:
randomly zooming in the target region, randomly zooming out the target region, or performing mirror image rotation on the target region.

For example, the performing target object segmentation on the original image to obtain the target object image and the background image includes:
inputting the original image into an image segmentation model to obtain the target object image and the background image, wherein the image segmentation model includes: a channel exchange network, a channel split network and a deep separable convolutional network.

The deep separable convolutional network includes a first channel convolutional sub-network, a deep convolutional sub-network, a second channel convolutional sub-network and a channel merge layer.

The channel exchange network, the channel split network, the first channel convolutional sub-network, the deep convolutional sub-network, the second channel convolutional sub-network and the channel merge layer are sequentially connected; and an output of the channel split network is in skip connection with an input of the channel merge layer.

The first channel convolutional sub-network includes a first channel convolutional layer, a nonlinear activation layer and a linear transformation layer; the deep convolutional sub-network includes a deep convolutional layer, a nonlinear activation layer and a linear transformation layer; the second channel convolutional sub-network includes a second channel convolutional layer, a nonlinear activation layer and a linear transformation layer; and the deep convolutional layer is composed of a plurality of parallel convolutional kernels.

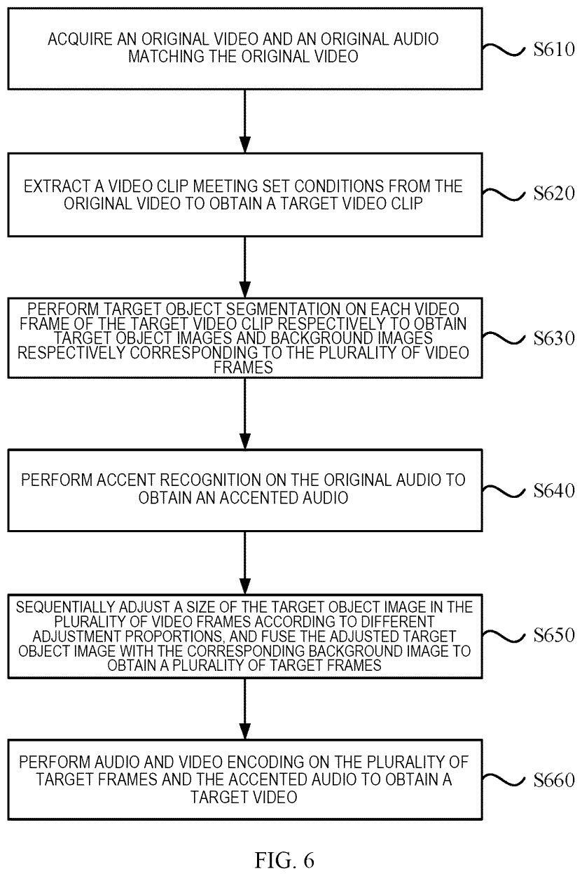

FIG. 6 is a flowchart of a method for video processing provided by another embodiment of the present disclosure. This embodiment may be applicable to a case of generating a target video based on an original video. The method may be performed by an apparatus for video processing. The apparatus may be composed of hardware and/or software and may usually be integrated into a device having a video processing function. The device may be an electronic device such as a server, a mobile terminal, or a server cluster. As shown in FIG. 6, the method includes the following steps.

In 610, an original video and an original audio matching the original video are acquired.

The original video may be captured by a user through a camera of a smart terminal, or stored locally, or downloaded from a video library in a network, or sent by other users. A source of the original video will not be limited here. The original audio may be an audio with a strong sense of rhythm.

In this embodiment, a mode of acquiring the original audio matching the original video may be: acquiring the original audio matching the original video according to a selection operation of the user; or recognizing type information of the original video; and acquiring the original audio matching the original video based on the type information.

A mode of selecting by the user may be specifying an audio by the user, or selecting by the user after acquiring an audio template provided by an APP.

A mode of recognizing the type information of the original video may be: inputting the original video into a type recognition model to obtain a type to which the original video belongs. The type recognition model may be obtained by training a set neural network. For example, after the type information of the original video is determined, a clip of audio is randomly selected from an audio library corresponding to the type information as an original audio. Types may include a natural scenery type, a character type, a building type, etc.

In 620, a video clip meeting set conditions is extracted from the original video to obtain a target video clip.

The target video clip may be understood as a video clip containing a transition video frame, or a video clip whose video frames have a difference less than a certain value. The transition video frame may be understood as a video frame having a difference greater than a certain value from a previous frame thereof, for example: a video frame in which other object enters a picture; and the video frames having a difference less than a certain value may be understood as photographing the same object for a long time.

In this embodiment, a mode of extracting the video clip meeting the set conditions from the original video to obtain the target video clip may be: acquiring feature vectors of each video frame in the original video; clustering the feature vectors to obtain a plurality of clustered initial video clips; and extracting a video clip meeting the set conditions from the plurality of initial video clips respectively based on the feature vectors to obtain the target video clip.

The feature vectors may represent feature information such as an image element and attribute included in each video frame in the original video, for example, the feature vectors may be quantitatively represented in a form of an array. The image elements may include a foreground image, a background image, etc. The attribute information may refer to at least one type of information such as an image structure, as well as a color, size, position, shape and style of the image element, for example, a layer position of the image element in a picture, color of the image, contrast of the image, brightness of the image, etc. Methods for acquiring the feature vectors may include, but are not limited to at least one of: a neural network method, a scale-invariant feature transform (SIFT) method, a speeded up robust features (SURF) method, etc.

The feature vectors are clustered, wherein a plurality of video frames in each cluster set are related to each other, for example, have a similarity exceeding a set threshold. A cluster analysis method may be a k-means algorithm, a spectral clustering algorithm, etc. For example, clustering is performed based on image elements exhibited in video frames. Exemplarily, the image element includes a human body or a subject object. Feature vectors in each cluster set are clustered to generate a plurality of initial video clips.

For example, in this embodiment, a mode of extracting the video clip meeting the set conditions from the plurality of initial video clips respectively based on the feature vectors to obtain the target video clip may be: calculating a distance between feature vectors of adjacent video frames; determining a video clip of a set duration containing the adjacent video frames as the target video clip, in a case where the distance is greater than a first threshold; determining a video clip within a first duration as the target video clip, in a case where the video clip within the first duration meets the following conditions: distances between feature vectors of adjacent video frames are all less than a second threshold, and a distance between a feature vector of an Nth frame and a weighted sum of feature vectors of first (N−1) frames is less than a third threshold.

N is greater than or equal to 1 and less than or equal to the number of frames contained in the video clip within the first duration. The calculating the distance between feature vectors of adjacent video frames may be understood as: calculating a distance between feature vectors of each two adjacent video frames in a video clip. Either an Euclidean distance formula or a Markov distance formula may be adopted for calculating the distance between feature vectors of adjacent video frames. If the obtained distance is greater than the first threshold, it indicates that a great change occurs between the adjacent video frames. If a change value has exceeded the set first threshold, it may be considered that the video frame undergoes a transition. Therefore, the video clip of the set duration containing the adjacent transition video frame is determined as the target video clip. If a distance between feature vectors of adjacent video frames within the first duration is less than the set threshold, and the distance between the feature vector of the Nth frame and a weighted sum of feature vector of first (N−1) frames is less than the third threshold, it may be considered that a video frame in a video clip within a set duration undergoes no transition, then the video clip of the first duration is determined as the target video clip. In this embodiment, the first duration, the first threshold, the second threshold, and the third threshold may be set according to needs. It may be clear that both the second threshold and the third threshold are less than the first threshold, and the second threshold and the third threshold may be the same or different.

Exemplarily, the feature vectors of adjacent video frames are sequentially represented as: x1, x2, x3, . . . , xn, where n represents the number of video frames. If a distance between a feature vector xn and a feature vector x(n−1) is greater than the first threshold, a video clip of a set duration containing video frames corresponding to the feature vector xn and the feature vector x(n−1) is determined as the target video clip. For example, a video clip 2 seconds prior to x(n−1) and a video clip 2 seconds posterior to xn are respectively selected, together with xn and x(n−1), to constitute the target video clip.

The feature vectors of adjacent video frames are sequentially represented as: x1, x2, x3, . . . , xn; corresponding weights are p1, p2, p3, . . . pn respectively, where n is greater than or equal to 1 and less than or equal to the number of frames contained in the video clip of the first duration. If the feature vectors x1, x2, x3, . . . , xn of adjacent video frames are each less than the second threshold within the first duration, a weighted sum of feature vectors of first (n−1) frames may be represented as S=p1*x1+p2*x2+p3*x3+. . . +p(n−1)*x(n−1), and a distance between a feature vector xn and S is less than the third threshold, the video clip of the first duration is determined as the target video clip. A greater weight is assigned for a video frame that is closer to the nth frame.

In 630, target object segmentation is performed on each video frame of the target video clip respectively to obtain target object images and background images respectively corresponding to the plurality of video frames.

The target object may be a human body or a subject object contained in the original video. In this embodiment, the target object in the original video firstly needs to be recognized, and then the recognized target object is segmented from the background to obtain a target object image and a background image. Exemplarily, FIG. 2 is a group of exemplary diagrams of performing target object segmentation on the video frame according to this embodiment. As shown in FIG. 2, the target object may be a fruit, an animal, a human body, or a vehicle, etc.

For example, the process of performing target object segmentation on each video frame of the target video clip respectively to obtain the target object images and the background images respectively corresponding to the plurality of video frames may be: performing human figure recognition on each video frame of the target video clip; determining the recognized human figure as a target object in response to recognizing a human figure; performing subject object recognition on each video frame of the target video clip, and determining the recognized subject object as a target object in response to recognizing no human figure; and segmenting the target object from the background to obtain the target object images and the background images respectively corresponding to the plurality of video frames.

In this embodiment, the human body is firstly taken as the target object. In response to no human figure in the video frame of the target video clip, a saliency segmentation algorithm may be adopted to recognize the subject object in the video frame of the target video clip. For example, firstly, human figure recognition is performed on each video frame of the target video clip; the human figure is segmented from the background to obtain a human body image and a background image in response to recognizing a human figure; the saliency segmentation algorithm is adopted to recognize the subject object in the video frame of the target video clip, and the subject object is segmented from the background to obtain a subject object image and a background image, in response to recognizing no human figure.

For example, the performing target object segmentation on each video frame of the target video clip to obtain the target object images and the background images may further be: inputting each video frame of the target video clip into an image segmentation model to obtain the target object images and the background images.

In this embodiment, in order to allow the model to be deployed on a mobile terminal, the model needs to be efficient and simple in computation with low computational complexity. In the embodiments of the present disclosure, a convolutional network is a deep separable convolutional network.

In 640, accent recognition is performed on the original audio to obtain an accented audio.

In 650, a size of the target object image in the plurality of video frames is adjusted in sequence according to different adjustment proportions, and the adjusted target object image is fused with the corresponding background image to obtain a plurality of target frames.

In this embodiment, when the size of the target object image in the plurality of video frames is adjusted, the adjustment proportion may increase firstly and then decrease according to a certain step length. In this way, the video has such an effect that the target object gradually becomes larger and then gradually becomes smaller to the original size. For example, the process of sequentially adjusting the size of the target object image in the plurality of video frames according to different adjustment proportions may be: acquiring the number of video frames contained in the target video clip; determining a change mode of the adjustment proportion according to the number of video frames, and acquiring adjustment proportions corresponding to the number of video frames; and adjusting the size of the target object image in the plurality of video frames sequentially according to the adjustment proportions corresponding to the number of video frames.

The number of adjustment proportions is equal to the number of video frames.

For example, the process of determining a change mode of the adjustment proportions according to the number of video frames and acquiring adjustment proportions corresponding to the number of video frames may be: assuming that the maximum adjustment proportion is M and the number of video frames is N, setting adjustment proportions corresponding to the number of first a% of video frames to change from small to large, that is, from 1 to M, such that a first change step length is (M−1)/(a%*N−1); and setting the adjustment proportions corresponding to the number of last (1−a%) of video frames to change from large to small, that is, from M to 1, such that the second change step length is (M−1)/((1−a%)*N−1). After the plurality of different adjustment proportions is acquired, the target object images are sequentially adjusted according to different adjustment proportions to obtain the plurality of adjusted target object images. Position information of a target object image in an original video frame is determined, and then a target frame is obtained by pasting the target object image directly back into the original video frame according to this position.

In 660, audio and video encoding is performed on the plurality of target frames and the accented audio to obtain a target video.

In this embodiment, the plurality of target frames needs to be aligned with the accented audio prior to performing audio and video encoding.

The accented audio includes an accent start point and an accent end point. The process of encoding the plurality of target frames and the accented audio to obtain the target video may be: aligning a first frame in the plurality of target frames with the accent start point, and aligning a last frame in the plurality of target frames with the accent end point; and performing audio and video encoding on the aligned video frames and accented audio to obtain the target video.

For example, if a plurality of accented audios is included, then audio and video encoding is performed on the plurality of target frames and the accented audios to obtain the target video.

In this embodiment, the process of performing audio and video encoding on the plurality of target frames and the accented audios to obtain the target video may be: for each accented audio, randomly selecting a target video clip from one or more target video clips, and performing audio and video encoding on a plurality of target frames corresponding to the selected target video clip and the accented audio to obtain a plurality of target videos; and splicing the plurality of target videos to obtain a spliced target video.

For example, prior to performing audio and video encoding on the plurality of images and the accented audio, the method further includes the following steps of: extracting a target region from the plurality of target frames; and executing at least one of the following processing on the target region: randomly zooming in the target region, randomly zooming out the target region, or performing mirror image rotation on the target region.

The embodiments of the present disclosure disclose a method, apparatus, device and storage medium for video processing. The original video and the original audio matching the original video are acquired; the video clip meeting set conditions is extracted from the original video to obtain the target video clip; target object segmentation is performed on each video frame of the target video clip respectively to obtain the target object images and the background images respectively corresponding to the plurality of video frames; accent recognition is performed on the original audio to obtain the accented audio; the size of the target object image in the plurality of video frames is sequentially adjusted according to different adjustment proportions, and the adjusted target object image is fused with the corresponding background image to obtain the plurality of target frames; and audio and video encoding is performed on the plurality of target frames and the accented audio to obtain the target video. According to the method for video processing provided by the embodiment of the present disclosure, audio and video encoding is performed on the target object image having the adjusted size and the accented audio to obtain the target video, so that the target video has a “kichiku” effect. This not only improves efficiency of video processing, but also enriches effect presented by the processed video.

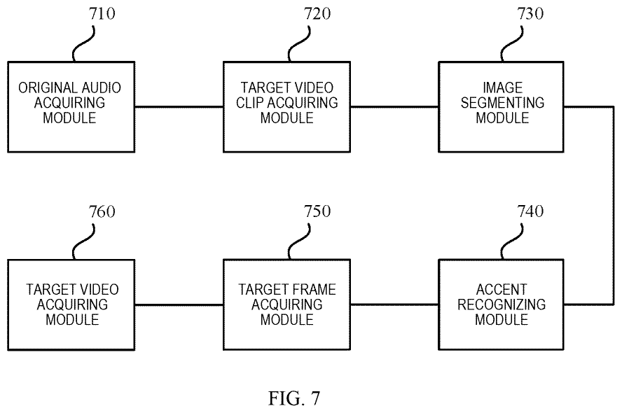

FIG. 7 is a structural schematic diagram of an apparatus for video processing provided by an embodiment of the present disclosure. As shown in FIG. 7, the apparatus includes:
an original audio acquiring module 710 configured to acquire an original video and an original audio matching the original video;
a target video clip acquiring module 720 configured to extract a video clip meeting set conditions from the original video to obtain a target video clip;
an image segmenting module 730 configured to perform target object segmentation on each video frame of the target video clip respectively to obtain target object images and background images respectively corresponding to the plurality of video frames;
an accent recognizing module 740 configured to perform accent recognition on the original audio to obtain an accented audio;
a target frame acquiring module 750 configured to sequentially adjust a size of the target object image in the plurality of video frames according to different adjustment proportions, and fuse the adjusted target object image with the corresponding background image to obtain a plurality of target frames; and
a target video acquiring module 760 configured to perform audio and video encoding on the plurality of target frames and the accented audio to obtain a target video.

For example, the original audio acquiring module 710 is further configured to:
acquire the original audio matching the original video according to a selection operation of the user; or
recognize type information of the original video; and acquire the original audio matching the original video based on the type information.

For example, the target video clip acquiring module 720 includes:
a feature vector acquiring unit configured to acquire feature vectors of each video frame in the original video;
an initial video clip acquiring unit configured to cluster the feature vectors to obtain a plurality of clustered initial video clips; and
a target video clip acquiring unit configured to extract a video clip meeting the set conditions respectively from the plurality of initial video clips based on the feature vectors to obtain the target video clip.

For example, the target video clip acquiring unit is configured to:
calculate a distance between feature vectors of adjacent video frames;
determine a video clip of a set duration containing the adjacent video frames as a target video clip, in a case where the distance is greater than a first threshold; and
determine a video clip of a first duration as the target video clip, in a case where the
video clip within the first duration meets the following conditions:
distances between feature vectors of adjacent video frames are all less than a second threshold, and a distance between a feature vector of an Nth frame and a weighted sum of feature vectors of first (N−1) frames is less than a third threshold, wherein N is greater than or equal to 1 and less than or equal to the number of frames contained in the video clip of the first duration.

For example, the image segmenting module 730 is further configured to:
perform human figure recognition on each video frame of the target video clip;
determine the recognized human figure as a target object in response to recognizing a human figure;
perform subject object recognition on each video frame of the target video clip, and determine the recognized subject object as a target object, in response to recognizing no human figure; and
segment the target object from the background to obtain target object images and background images respectively corresponding to the plurality of video frames.

For example, the accent recognizing module 740 is further configured to: denoise the original audio;
detect a note start point of the denoised original audio to obtain a note start point;
detect a peak of the denoised original audio by using a peak-picking algorithm to
obtain a peak point meeting set conditions; and
determine the accented audio according to the peak point and the note start point.

For example, the target frame acquiring module 750 is further configured to:
acquire the number of video frames contained in the target video clip;
determine a change mode of the adjustment proportion according to the number of video frames, and acquire adjustment proportions corresponding to the number of video frames, wherein the change mode includes a change trend and a change step length;
adjust a size of the target object image in the plurality of video frames sequentially according to the adjustment proportions corresponding to the number of video frames.

For example, the target video acquiring module 760 is further configured to:
align a first frame in the plurality of target frames with the accent start point, and
align a last frame in the plurality of target frames with an accent end point; and
perform audio and video encoding on the aligned video frames and accented audio to obtain the target video.

For example, the target video acquiring module 760 is further configured to:
if a plurality of accented audios is included, for each accented audio, randomly select a target video clip from one or more target video clips, and perform audio and video encoding on a plurality of target frames corresponding to the selected target video clip and the accented audio to obtain a plurality of target videos; and
splice the plurality of target videos to obtain a spliced target video.

For example, the apparatus further includes a target region processing module configured to:
extract a target region from the plurality of target frames, wherein the target region contains some or all pixel points of the target object, and a center point of the target region is a pixel point of the target object; and
perform at least one of the following processing on the target region:
randomly zooming in the target region, randomly zooming out the target region, or performing mirror image rotation on the target region.

For example, the image segmenting module 730 is further configured to:
input each video frame of the target video clip into an image segmentation model respectively to obtain the target object images and the background images corresponding to the plurality of video frames, wherein the image segmentation model includes: a channel exchange network, a channel split network and a deep separable convolutional network.

The deep separable convolutional network includes a first channel convolutional sub-network, a deep convolutional sub-network, a second channel convolutional sub-network and a channel merge layer.

The channel exchange network, the channel split network, the first channel convolutional sub-network, the deep convolutional sub-network, the second channel convolutional sub-network and the channel merge layer are sequentially connected; and an output of the channel split network is in skip connection with an input of the channel merge layer.

The first channel convolutional sub-network includes a first channel convolutional layer, a nonlinear activation layer and a linear transformation layer; the deep convolutional sub-network includes a deep convolutional layer, a nonlinear activation layer and a linear transformation layer; the second channel convolutional sub-network includes a second channel convolutional layer, a nonlinear activation layer and a linear transformation layer; and the deep convolutional layer is composed of a plurality of parallel convolutional kernels.

The above-described computer readable medium carries one or more programs; and the above-described one or more programs, when executed by the electronic device, cause the electronic device to: acquire an original video and an original audio matching the original video; extract a video clip meeting set conditions from the original video to obtain a target video clip; perform target object segmentation on each video frame of the target video clip respectively to obtain target object images and background images respectively corresponding to the plurality of video frames; perform accent recognition on the original audio to obtain an accented audio; sequentially adjust a size of the target object image in the plurality of video frames according to different adjustment proportions, and fuse the adjusted target object image with the corresponding background image to obtain a plurality of target frames; and perform audio and video encoding on the plurality of target frames and the accented audio to obtain a target video.

According to one or more embodiments among the embodiments of the present disclosure, an embodiment of the present disclosure discloses a method for video processing. The method includes:
acquiring an original video and an original audio matching the original video;
extracting a video clip meeting set conditions from the original video to obtain a target video clip;
performing target object segmentation on each video frame of the target video clip respectively to obtain target object images and background images respectively corresponding to the plurality of video frames;
performing accent recognition on the original audio to obtain an accented audio;
sequentially adjusting a size of the target object image in the plurality of video frames according to different adjustment proportions, and fusing the adjusted target object image with corresponding background image to obtain a plurality of target frames; and
performing audio and video encoding on the plurality of target frames and the accented audio to obtain a target video.

For example, the acquiring the original audio matching the original video includes:
acquiring the original audio matching the original video according to a selection operation of a user; or
recognizing type information of the original video; and
acquiring the original audio matching the original video based on the type information.

For example, the extracting the video clip meeting the set conditions from the original video to obtain the target video clip includes:
acquiring feature vectors of each video frame in the original video;
clustering the feature vectors to obtain a plurality of clustered initial video clips; and
extracting a video clip meeting the set conditions from the plurality of initial video clips based on the feature vectors respectively to obtain the target video clip.

For example, the extracting the video clip meeting the set conditions from the plurality of initial video clips based on the feature vectors respectively to obtain the target video clip includes:
calculating a distance between feature vectors of adjacent video frames;
determining a video clip of a set duration containing the adjacent video frames as a target video clip, in a case where the distance is greater than a first threshold;
determining a video clip within the first duration as a target video clip, in a case where the video clip within the first duration meets the following conditions:
distances between feature vectors of adjacent video frames are all less than a second threshold, and a distance between a feature vector of an Nth frame and a weighted sum of feature vectors of first (N−1) frames is less than a third threshold, where N is greater than or equal to 1 and less than or equal to the number of frames contained in the video clip of the first duration.

For example, the performing target object segmentation on each video frame of the target video clip respectively to obtain target object images and background images respectively corresponding to the plurality of video frames includes:
performing human figure recognition on each video frame of the target video clip;
determining the recognized human figure as a target object in response to recognizing a human figure;
performing subject object recognition on each video frame of the target video clip, and determining the recognized subject object as a target object, in response to recognizing no human figure; and
segmenting the target object from the background to obtain the target object images and the background images respectively corresponding to the plurality of video frames.

For example, the performing accent recognition on the original audio to obtain the accented audio includes:
denoising the original audio;
detecting a note start point of the denoised original audio to obtain a note start point;
detecting a peak of the denoised original audio by using a peak-picking algorithm to obtain a peak point meeting set conditions; and
determining the accented audio according to the peak point and the note start point.

For example, the sequentially adjusting the sizes of the target object images in the plurality of video frames according to different adjustment proportions includes:
acquiring the number of video frames contained in the target video clip;
determining a change mode of the adjustment proportion according to the number of video frames, and acquiring adjustment proportions corresponding to the number of video frames, wherein the change mode includes a change trend and a change step length; and
adjusting the sizes of the target object images in the plurality of video frames sequentially according to the adjustment proportions corresponding to the number of video frames.

For example, the accented audio includes an accent start point and an accent end point. The performing audio and video encoding on the plurality of target frames and the accented audio to obtain the target video includes:
aligning a first frame in the plurality of target frames with the accent start point, and aligning a last frame in the plurality of target frames with the accent end point; and
performing audio and video encoding on the aligned video frames and accented audio to obtain the target video.

For example, if a plurality of accented audios is included, the performing audio and video encoding on the plurality of target frames and the accented audios to obtain the target video includes:
for each accented audio, randomly selecting a target video clip from one or more target video clips, and performing audio and video encoding on a plurality of target frames corresponding to the selected target video clip and the accented audio to obtain a plurality of target videos; and
splicing the plurality of target videos to obtain a spliced target video.

For example, prior to performing audio and video encoding on the plurality of target frames and the accented audio, the method further includes:
extracting a target region from the plurality of target frames, wherein the target region contains some or all pixel points of the target object, and a center point of the target region is a pixel point of the target object; and
executing at least one of the following processing on the target region:
randomly zooming in the target region, randomly zooming out the target region, or performing mirror image rotation on the target region.

For example, the performing target object segmentation on each video frame of the target video clip respectively to obtain the target object images and background images respectively corresponding to the plurality of video frames includes:
inputting each video frame of the target video clip respectively into an image segmentation model to obtain the target object images and the background images corresponding to the plurality of video frames, wherein the image segmentation model includes: a channel exchange network, a channel split network and a deep separable convolutional network.

The deep separable convolutional network includes a first channel convolutional sub-network, a deep convolutional sub-network, a second channel convolutional sub-network and a channel merge layer.

The channel exchange network, the channel split network, the first channel convolutional sub-network, the deep convolutional sub-network, the second channel convolutional sub-network and the channel merge layer are sequentially connected; and an output of the channel split network is in skip connection with an input of the channel merge layer.

The first channel convolutional sub-network includes a first channel convolutional layer, a nonlinear activation layer and a linear transformation layer; the deep convolutional sub-network includes a deep convolutional layer, a nonlinear activation layer and a linear transformation layer; the second channel convolutional sub-network includes a second channel convolutional layer, a nonlinear activation layer and a linear transformation layer; and the deep convolutional layer is composed of a plurality of parallel convolutional kernels.

An embodiment of the present disclosure discloses a method for video processing. The method includes:
acquiring an original image and an original audio;
performing target object segmentation on the original image to obtain a target object image and a background image;
performing accent recognition on the original audio to obtain an accented audio;
adjusting a size of the target object image according to different adjustment proportions to obtain a plurality of adjusted target object images;
fusing the plurality of adjusted target object images respectively with the background image to obtain a plurality of target images; and
performing audio and video encoding on the plurality of target images and the accented audio to obtain a target video.

An embodiment of the present disclosure discloses an apparatus for video processing. The apparatus includes:
an original audio acquiring module configured to acquire an original image and an original audio;
an image segmenting module configured to perform target object segmentation on the original image to obtain a target object image and a background image;
an accent recognizing module configured to perform accent recognition on the original audio to obtain an accented audio;
a target object image size adjusting module configured to adjust a size of the target object image according to different adjustment proportions to obtain a plurality of adjusted target object images;
a target image acquiring module configured to fuse the plurality of adjusted target object images respectively with the background image to obtain a plurality of target images; and
a target video acquiring module configured to perform audio and video encoding on the plurality of target images and the accented audio to obtain a target video.

For example, the original image is a video frame corresponding to a target video clip extracted from the original video; and the original audio matches the original video.

The original audio acquiring module is further configured to acquire the original video.

The apparatus for video processing further includes a target video clip acquiring module configured to extract a video clip meeting set conditions from the original video to obtain a target video clip.

The image segmenting module is further configured to perform target object segmentation on each video frame of the target video clip respectively to obtain target object images and background images respectively corresponding to the plurality of video frames.

The target object image size adjusting module is further configured to sequentially adjust sizes of the target object images in the plurality of video frames according to different adjustment proportions.

The apparatus for video processing further includes a target frame acquiring module configured to fuse the adjusted target object images in the plurality of video frames with the corresponding background images to obtain a plurality of target frames.

The target video acquiring module is further configured to perform audio and video encoding on the plurality of target frames and the accented audio to obtain a target video.

1. A method for video processing, comprising:
acquiring an original image and an original audio;
performing target object segmentation on the original image to obtain a target object image and a background image;
performing accent recognition on the original audio to obtain an accented audio;
adjusting a size of the target object image according to different adjustment proportions to obtain a plurality of adjusted target object images;
fusing the plurality of adjusted target object images respectively with the background image to obtain a plurality of target images; and
performing audio and video encoding on the plurality of target images and the accented audio to obtain a target video.

2. The method of claim 1, wherein the original audio matches the original image.

3. The method of claim 2, wherein the acquiring the original audio comprises:
acquiring the original audio according to a selection operation of a user; or
recognizing type information of the original image; and acquiring the original audio based on the type information.

4. The method of claim 2, wherein the performing target object segmentation on the original image to obtain the target object image and the background image comprises:
performing human figure recognition on the original image;
in response to determining that a human figure is recognized, determining the recognized human figure as a target object;
in response to determining that no human figure is recognized, performing subject object recognition on the original image, and determining the recognized subject object as a target object; and
segmenting the target object from the background to obtain the target object image and the background image.

5. The method of claim 2, wherein the performing accent recognition on the original audio to obtain the accented audio comprises:
denoising the original audio;
detecting a note start point of the denoised original audio to obtain a note start point;
detecting a peak of the denoised original audio by using a peak-picking algorithm to obtain a peak point satisfying a preset condition; and
determining the accented audio based on the peak point and the note start point.

6. The method of claim 2, wherein the adjusting the size of the target object image according to different adjustment proportions to obtain the plurality of adjusted target object images comprises:
determining the number of images which are required based on a duration of the accented audio;
determining a change mode of the adjustment proportion based on the number of images to obtain a plurality of different adjustment proportions, the change mode comprising a change trend and a change step length; and
adjusting the size of the target object image respectively according to the plurality of different adjustment proportions to obtain adjusted target object images corresponding to the number of images.

7. The method of claim 2, wherein the accented audio comprises an accent start point and an accent end point; and the encoding the plurality of target images and the accented audio to obtain the target video comprises:
aligning a first frame in the plurality of target images with the accent start point, and aligning a last frame in the plurality of target images with the accent end point; and
performing audio and video encoding on the plurality of aligned target images and accented audio to obtain the target video.

8. The method of claim 2, prior to performing audio and video encoding on the plurality of target images and the accented audio, the method further comprising:
extracting a target region from the plurality of target images, the target region containing some or all pixel points of the target object, and a center point of the target region being a pixel point of the target object; and
executing at least one of the following processing on the target region:
randomly zooming in the target region, randomly zooming out the target region, or performing mirror image rotation on the target region.

9. The method of claim 2, wherein the performing target object segmentation on the original image to obtain the target object image and the background image comprises:
inputting the original image into an image segmentation model to obtain the target object image and the background image, wherein the image segmentation model comprises: a channel exchange network, a channel split network and a deep separable convolutional network;
the deep separable convolutional network comprises a first channel convolutional sub-network, a deep convolutional sub-network, a second channel convolutional sub-network and a channel merge layer;
the channel exchange network, the channel split network, the first channel convolutional sub-network, the deep convolutional sub-network, the second channel convolutional sub-network and the channel merge layer are sequentially connected; and
an output of the channel split network is in skip connection with an input of the channel merge layer;
the first channel convolutional sub-network comprises a first channel convolutional layer, a nonlinear activation layer and a linear transformation layer; the deep convolutional sub-network comprises a deep convolutional layer, a nonlinear activation layer and a linear transformation layer; the second channel convolutional sub-network comprises a second channel convolutional layer, a nonlinear activation layer and a linear transformation layer; and the deep convolutional layer is composed of a plurality of parallel convolutional kernels.

10. The method of claim 1, wherein the original image is a video frame corresponding to a target video clip extracted from the original video; the original audio matches the original video; and the method further comprises:
acquiring the original video;
extracting a video clip meeting set conditions from the original video to obtain the target video clip;
the performing target object segmentation on the original image to obtain the target object image and a background image comprises: performing target object segmentation on each video frame of the target video clip respectively to obtain target object images and background images respectively corresponding to the plurality of video frames;
the adjusting the size of the target object image according to different adjustment proportions comprises: sequentially adjusting sizes of the target object images in the plurality of video frames according to different adjustment proportions; and
the performing audio and video encoding on the plurality of target images and the accented audio comprises: performing audio and video encoding on the plurality of target frames and the accented audio to obtain a target video, the plurality of target frames being obtained by fusing the adjusted target object images in the plurality of video frames with the corresponding background image.

11. The method of claim 10, wherein the acquiring the original audio comprises:
acquiring the original audio matching the original video according to a selection operation of a user; or
recognizing type information of the original video; and
acquiring the original audio matching the original video based on the type information.

12. The method of claim 10, wherein the extracting the video clip meeting set conditions from the original video to obtain the target video clip comprises:
acquiring feature vectors of each video frame in the original video;
clustering the feature vectors to obtain a plurality of clustered initial video clips; and
extracting a video clip meeting the set conditions respectively from the plurality of initial video clips based on the feature vectors to obtain the target video clip.

13. (canceled)

14. The method of claim 10, wherein the performing target object segmentation on each video frame of the target video clip respectively to obtain the target object images and background images respectively corresponding to the plurality of video frames comprises:
performing human figure recognition on each video frame of the target video clip;
determining the recognized human figure as a target object, in response to determining that a human figure is recognized;
performing subject object recognition on each video frame of the target video clip, and determining the recognized subject object as a target object, in response to determining that no human figure is recognized; and
segmenting the target object from the background to obtain the target object images and the background images respectively corresponding to the plurality of video frames.

15. The method of claim 10, wherein the performing accent recognition on the original audio to obtain the accented audio comprises:
denoising the original audio;
detecting a note start point of the denoised original audio to obtain a note start point;
detecting a peak of the denoised original audio by using a peak-picking algorithm to obtain a peak point meeting set conditions; and
determining the accented audio according to the peak point and the note start point.

16. The method of claim 10, wherein the sequentially adjusting sizes of the target object images in the plurality of video frames according to different adjustment proportions comprises:
acquiring the number of video frames contained in the target video clip;
determining a change mode of the adjustment proportion according to the number of video frames, and acquiring adjustment proportions corresponding to the number of video frames, the change mode comprising a change trend and a change step length; and
adjusting the sizes of the target object images in the plurality of video frames sequentially according to the adjustment proportions corresponding to the number of video frames.

17. The method of claim 10, wherein the accented audio comprises an accent start point and an accent end point; and the performing audio and video encoding on the plurality of target frames and the accented audio to obtain the target video comprises:
aligning a first frame in the plurality of target frames with the accent start point, and aligning a last frame in the plurality of target frames with the accent end point; and
performing audio and video encoding on the aligned video frames and accented audio to obtain the target video.

18. (canceled)

19. The method of claim 10, prior to performing audio and video encoding on the plurality of target frames and the accented audio, the method further comprising:
extracting a target region from the plurality of target frames, the target region containing some or all pixel points of the target object, a center point of the target region being a pixel point of the target object; and
executing at least one of the following processing on the target region:
randomly zooming in the target region, randomly zooming out the target region, or performing mirror image rotation on the target region.

20. The method of claim 10, wherein the performing target object segmentation on each video frame of the target video clip respectively to obtain target object images and background images respectively corresponding to the plurality of video frames comprises:
inputting each video frame of the target video clip respectively into an image segmentation model to obtain the target object images and the background images corresponding to the plurality of video frames, wherein the image segmentation model comprises: a channel exchange network, a channel split network and a deep separable convolutional network;
the deep separable convolutional network comprises a first channel convolutional sub-network, a deep convolutional sub-network, a second channel convolutional sub-network and a channel merge layer;
the channel exchange network, the channel split network, the first channel convolutional sub-network, the deep convolutional sub-network, the second channel convolutional sub-network and the channel merge layer are sequentially connected; and an output of the channel split network is in skip connection with an input of the channel merge layer;
the first channel convolutional sub-network comprises a first channel convolutional layer, a nonlinear activation layer and a linear transformation layer; the deep convolutional sub-network comprises a deep convolutional layer, a nonlinear activation layer and a linear transformation layer; the second channel convolutional sub-network comprises a second channel convolutional layer, a nonlinear activation layer and a linear transformation layer; and the deep convolutional layer is composed of a plurality of parallel convolutional kernels.

21-23. (canceled)

24. An electronic device, comprising:
one or more processing devices;
a storage device configured to store one or more programs, wherein
the one or more programs, when executed by the one or more processing devices, cause the one or more processing devices to implement operations comprising:
acquiring an original image and an original audio;
performing target object segmentation on the original image to obtain a target object image and a background image;
performing accent recognition on the original audio to obtain an accented audio;
adjusting a size of the target object image according to different adjustment proportions to obtain a plurality of adjusted target object images;
fusing the plurality of adjusted target object images respectively with the background image to obtain a plurality of target images; and
performing audio and video encoding on the plurality of target images and the accented audio to obtain a target video.

25. A non-transitory computer readable medium, having a computer program stored thereon, wherein the program, when executed by a processing device, causes the processing device to implement operations comprising:
acquiring an original image and an original audio;
performing target object segmentation on the original image to obtain a target object image and a background image;
performing accent recognition on the original audio to obtain an accented audio;
adjusting a size of the target object image according to different adjustment proportions to obtain a plurality of adjusted target object images;
fusing the plurality of adjusted target object images respectively with the background image to obtain a plurality of target images; and
performing audio and video encoding on the plurality of target images and the accented audio to obtain a target video.
